(19) United States
(12) Patent Application Publication
(10) Pub. No.: US 2024/0329255 A1
(43) Pub. Date: Oct. 3, 2024

(54) LASER RADAR DEVICE

(71) Applicant: Mitsubishi Electric Corporation, Tokyo (JP)

(72) Inventors: Yusuke ITO, Tokyo (JP); Nobuyuki YOSHIKAWA, Tokyo (JP); Takayuki KITAMURA, Tokyo (JP); Masaharu IMAKI, Tokyo (JP)

(73) Assignee: Mitsubishi Electric Corporation, Tokyo (JP)

(21) Appl. No.: 18/744,062

(22) Filed: Jun. 14, 2024

Related U.S. Application Data
(63) Continuation of application No. PCT/JP2022/005312, filed on Feb. 10, 2022.

(51) Int. Cl. G01S 17/95; G01S 7/48; G01S 17/58

(52) U.S. Cl. CPC G01S 17/95; G01S 7/4808; G01S 17/58

(57) ABSTRACT

A laser radar device according to the technique of the present disclosure is a laser radar device that scans a laser beam and measures a wind speed field of observation environment, and includes a signal processor including a spectrum conversion processor, an integration processor, a wind speed field calculator, and a algorithm learning AI, and in which the spectrum conversion processor performs FFT processing on a beat signal that is a time-series digital signal, and generates spectrum data, the integration processor performs integration processing on the spectrum data, the wind speed field calculator calculates the wind speed field by referring to information on data processed by the integration processor, the algorithm learning AI includes a trained artificial intelligence, and interpolates an observation result by referring to information on the wind speed field.

### CROSS REFERENCE TO RELATED APPLICATION

This application is a Continuation of PCT International Application No. PCT/JP2022/005312, filed on Feb. 10, 2022, which is hereby expressly incorporated by reference into the present application.

### TECHNICAL FIELD

The technique of the present disclosure relates to a laser radar device.

### BACKGROUND ART

There is known a technique of a laser radar that measures a moving speed of fine liquid or solid particles (aerosol) floating in the atmosphere using a principal similar to that of a weather radar, and obtaining a wind speed and a wind direction.

For example, Patent Literature 1 discloses a technique of selecting a laser radar device that is used for a wind farm control system, and measures wind vectors from a plurality of laser radar devices.

### CITATION LIST

### Patent Literature

Patent Literature 1: WO2018/198225 A

### SUMMARY OF INVENTION

### Technical Problem

In a case where a laser radar device scans a beam and measures a wind speed field of observation environment, a solution is conceived, for example, to increase a sampling speed, that is, to improve hardware performance in order to increase the number of observation points in the observation environment and make wind speed field data dense. Improving hardware performance has a limitation, and leads to rise in cost.

Another possible solution is to simulate a wind condition using large calculation resources such a supercomputer and make wind speed field data to be obtained dense. However, simulating the wind condition in real time lacks reality.

An object of the technique of the present disclosure is to solve the above problem, and provide a laser radar device that generates dense wind speed field data in a much shorter time than a time required to perform fluid simulation.

### Solution to Problem

A laser radar device according to the technique of the present disclosure is a laser radar device that scans a laser beam and measures a wind speed field of observation environment, and includes a signal processor including a spectrum conversion processor, an integration processor, a wind speed field calculator, and a algorithm learning AI, and in which the spectrum conversion processor performs FFT processing on a beat signal that is a time-series digital signal, and generates spectrum data, the integration processor performs integration processing on the spectrum data, the wind speed field calculator calculates the wind speed field by referring to information on data processed by the integration processor, the algorithm learning AI includes a trained artificial intelligence, and interpolates an observation result by referring to information on the wind speed field, the wind speed field calculator calculates information on a structure in the observation environment in addition to the information on the wind speed field, and, the algorithm learning AI interpolates an observation point, even if the point to be interpolated is a blind spot of the structure in the observation environment.

### Advantageous Effects of Invention

The laser radar device according to the technique of the present disclosure employs the above configuration, and consequently can interpolate an observation result, and generate dense wind speed field data in a much shorter time than a time required to perform fluid simulation.

### BRIEF DESCRIPTION OF DRAWINGS

FIG. 1 is a block diagram illustrating a configuration of a laser radar device according to Embodiment 1.

FIG. 2 is a schematic view illustrating a configuration example of a beam scan optical system 10 of the laser radar device according to Embodiment 1.

FIGS. 3A and 3B illustrate examples of graphs showing beat signal in time domain.

FIG. 4 illustrates an example of a map showing observation points of the laser radar device according to Embodiment 1.

FIG. 5 illustrates an example of a map illustrating how a learning algorithm unit of a signal processing unit according to Embodiment 1 interpolates an observation result.

FIG. 6 is a schematic view illustrating a principal that the learning algorithm unit of the signal processing unit according to Embodiment 1 interpolates the observation result.

FIG. 7 illustrates an example of a map in a case where the laser radar device according to Embodiment 1 is applied to navigation assistance for an aerial moving body.

FIG. 8 illustrates an example of a three-dimensional map in a case where the laser radar device according to Embodiment 1 is applied to navigation assistance of an aerial moving body.

FIG. 9 is a block diagram illustrating a configuration of a laser radar device according to Embodiment 2.

### DESCRIPTION OF EMBODIMENTS

The technique of the present disclosure relates to a laser radar device. The laser radar device is also referred to as a coherent Doppler Lidar or simply as a Doppler Lidar.

### Embodiment 1

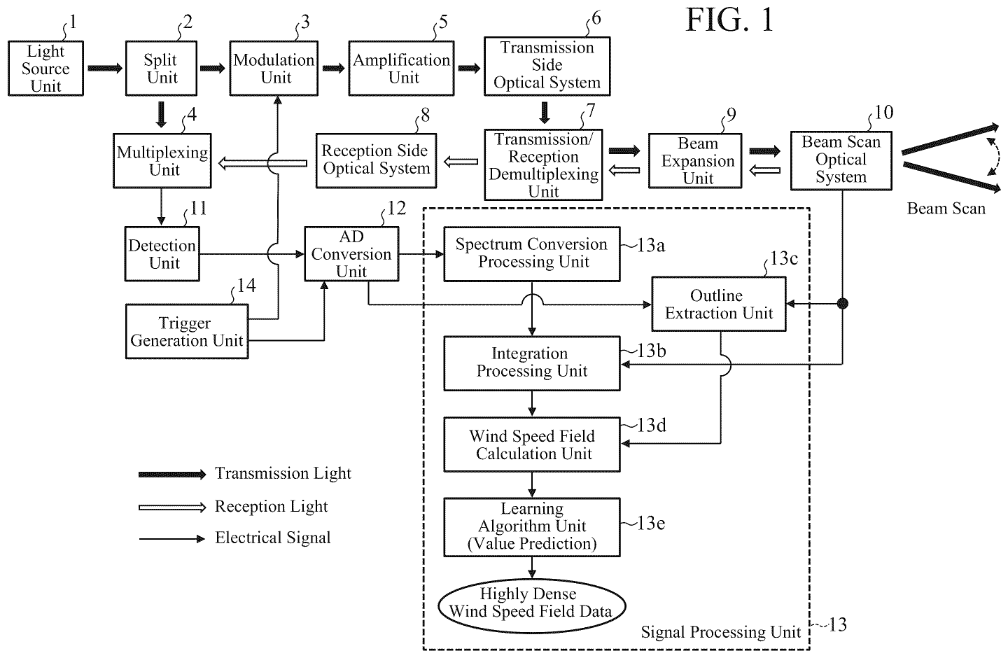

FIG. 1 is a block diagram illustrating a configuration of a laser radar device according to Embodiment 1. As illustrated in FIG. 1, the laser radar device according to Embodiment 1 includes a light source unit 1, a split unit 2, a modulation unit 3, a multiplexing unit 4, an amplification unit 5, a transmission side optical system 6, a transmission/reception demultiplexing unit 7, a reception side optical system 8, a beam expansion unit 9, a beam scan optical system 10, a detection unit 11, an AD conversion unit 12, a signal processing unit 13, and a trigger generation unit 14.

As illustrated in FIG. 1, the signal processing unit 13 of the laser radar device according to Embodiment 1 includes a spectrum conversion processing unit 13a, an integration processing unit 13b, an outline extraction unit 13c, a wind speed field calculation unit 13d, and a learning algorithm unit 13e.

Each functional block of the laser radar device according to Embodiment 1 is connected as illustrated in FIG. 1. Arrows that connect the functional blocks illustrated in FIG. 1 indicate one of transmission light, reception light, and an electrical signal.

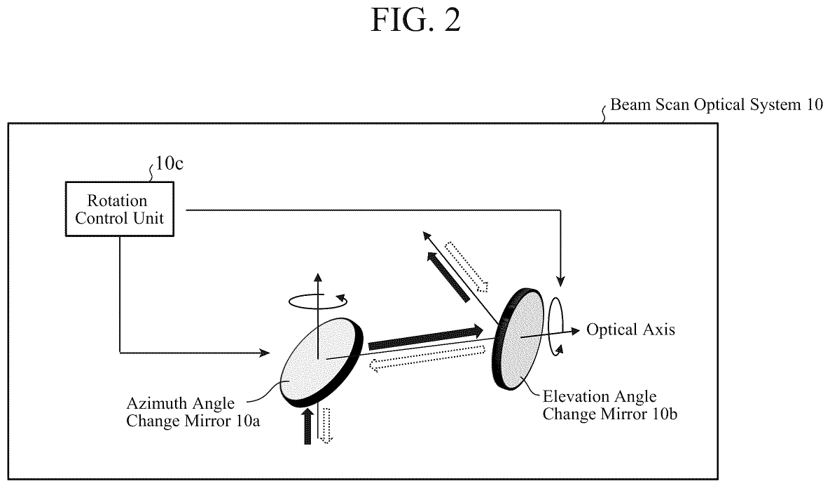

FIG. 2 is a schematic view illustrating a configuration example of the beam scan optical system 10 of the laser radar device according to Embodiment 1. As illustrated in FIG. 2, the beam scan optical system 10 of the laser radar device according to Embodiment 1 may include an azimuth angle change mirror 10a, an elevation angle change mirror 10b, and a rotation control unit 10c.

Similar to FIG. 1, arrows illustrated in FIG. 2 indicate one of transmission light, reception light, and an electrical signal.

### <<Light Source Unit 1>>

The light source unit 1 may be, for example, a semiconductor laser or a solid state laser.

### <<Split Unit 2>>

The split unit 2 may be, for example, a 1:2 optical coupler or a half mirror.

### <<Modulation Unit 3>>

The modulation unit 3 may be, for example, an LN modulator, an AOM, or an SOA.

### <<Multiplexing Unit 4>>

The multiplexing unit 4 may be, for example, a 2:2 optical coupler or a half mirror.

### <<Amplification Unit 5>>

The amplification unit 5 may be, for example, an optical fiber amplifier.

### <<Transmission Side Optical System 6>>

The transmission side optical system 6 may include, for example, a convex lens, a concave lens, an aspherical lens, or a combination thereof. Furthermore, the transmission side optical system 6 may include a mirror.

### <<Transmission/Reception Demultiplexing Unit 7>>

The transmission/reception demultiplexing unit 7 may be, for example, a circulator or a polarization beam splitter.

### <<Reception Side Optical System 8>>

The reception side optical system 8 may include, for example, a convex lens, a concave lens, an aspherical lens, or a combination thereof similar to the transmission side optical system 6. Furthermore, the reception side optical system 8 may include a mirror similar to the transmission side optical system 6.

### <<Beam Expansion Unit 9>>

The beam expansion unit 9 may be, for example, a beam expander.

### <<Beam Scan Optical System 10>>

The beam scan optical system 10 may include, for example, a mirror or a wedge prism. As described above, the configuration example of the beam scan optical system 10 is illustrated in FIG. 2. The rotation control unit 10c that is a component illustrated in FIG. 2 may include, for example, a motor and a motor driver.

### <<Detection Unit 11>>

The detection unit 11 may be, for example, a balanced receiver.

### <<AD Conversion Unit 12>>

The AD conversion unit 12 may be a commercially available general-purpose analog-to-digital converter.

### <<Signal Processing Unit 13>>

The signal processing unit 13 may include a processing circuit. The processing circuit may be dedicated hardware, or may be a CPU (that is also referred to as a Central Processing Unit, a central processing device, a processing device, an arithmetic operation device, a microprocessor, a microcomputer, a processor, or a DSP) that executes programs stored in a memory. In a case where the processing circuit is the dedicated hardware, the processing circuit corresponds to, for example, a single circuit, a composite circuit, a programmed processor, a parallel-programmed processor, an ASIC, an FPGA, or a combination thereof.

As described above, the signal processing unit 13 does not need to be implemented by large calculation resources such as a supercomputer, and may be a general personal computer.

### <<Trigger Generation Unit 14>>

The trigger generation unit 14 may include a processing circuit similar to the signal processing unit 13.

### <<Operation of Laser Radar Device According to Embodiment 1>>

The light source unit 1 outputs continuous wave light having a single frequency. The output continuous wave light is sent to the split unit 2.

The split unit 2 distributes the sent continuous wave light to two systems. Part of the distributed continuous wave light is sent to the modulation unit 3, and the rest is sent to the multiplexing unit 4. The continuous wave light sent to the multiplexing unit 4 is used as a reference, that is, reference light.

The trigger generation unit 14 generates a trigger signal of a predetermined repetition cycle. The trigger signal generated by the trigger generation unit 14 is sent to the modulation unit 3 and the AD conversion unit 12. A voltage value and a current value of the trigger signal may be determined on the basis of the specifications of the modulation unit 3 and the AD conversion unit 12.

The modulation unit 3 converts the transmission light sent from the split unit 2 into pulsed light on the basis of the trigger signal, and further gives frequency shift to the pulsed light. The transmission light processed by the modulation unit 3 is sent to the transmission side optical system 6 via the amplification unit 5.

The transmission side optical system 6 converts the sent transmission light in such a manner that the transmission light has a designed beam diameter and beam expansion angle. The transmission light processed by the transmission side optical system 6 is sent to the beam scan optical system 10 via the transmission/reception demultiplexing unit 7 and the beam expansion unit 9.

The beam scan optical system 10 scans the sent transmission light toward the atmosphere. Note that the term “scan” has the same meaning as those of “to perform scanning” and “scanning”. The beam scan optical system 10 scans the transmission light by, for example, changing an azimuth angle direction (hereinafter, referred to as an “AZ direction”), an elevation angle direction (hereinafter, an “EL direction”), or both of the AZ direction and the EL direction at a certain angular velocity. Information on a beam scanning direction of the beam scan optical system 10, more specifically, information on an azimuth angle (θ_{AZ}) and an elevation angle (θ_{EL}) of a beam is sent to the integration processing unit 13b of the signal processing unit 13. Note that AZ of the AZ direction are first two letters of Azimuth that is an English name of an azimuth angle, and EL of the EL direction are first two letters of Elevation that is an English name of the elevation angle.

Transmission light scanned toward the atmosphere is scattered or reflected by targets such as aerosol in the atmosphere and structures such as buildings. Part of the scattered or reflected light is guided as reception light to the reception side optical system 8 via the beam scan optical system 10, the beam expansion unit 9, and the transmission/reception demultiplexing unit 7.

The frequency of the reception light reflected by the aerosol in the atmosphere causes Doppler shift matching a wind speed compared to the frequency of the transmission light. The laser radar device according to the technique of the present disclosure performs heterodyne detection, calculates a Doppler shift amount matching this wind speed, and measures the wind speed in a laser radiation direction. Heterodyne means generating a new frequency by synthesizing or multiplying two vibration waveforms. Mixing the two frequencies generates two new frequencies in accordance with the property of the trigonometric function. The one frequency is a sum of the two frequencies, and the other one is a difference between the two frequencies. Heterodyne detection is a detection method that uses the property of this heterodyne.

The multiplexing unit 4 multiplexes and causes the transmission light from the split unit 2 and the reception light from the reception side optical system 8 to interfere with each other. Light multiplexed by the multiplexing unit 4 has the frequency that is a difference between the frequency of the transmission light and the frequency of the reception light, that is, a Doppler shift frequency (hereinafter, simply referred to as a “Doppler frequency”) depending on the property of heterodyne. A signal multiplexed and caused to interfere by the multiplexing unit 4 is referred to as an “interference beat signal” or simply as a “beam signal”. The light multiplexed by the multiplexing unit 4 is sent to the detection unit 11.

The detection unit 11 converts the sent light into an analog electrical signal. The electrical signal processed by the detection unit 11, that is, a beat signal is sent to the AD conversion unit 12.

The AD conversion unit 12 converts the beat signal of the analog electrical signal into a digital electrical signal, that is, a time-series digital signal in synchronization with the trigger signal. The time-series digital signal is sent to the spectrum conversion processing unit 13a and the outline extraction unit 13c of the signal processing unit 13.

The spectrum conversion processing unit 13a of the signal processing unit 13 divides the sent time-series digital signal by a predetermined time window length, and repeats finite Fourier transform.

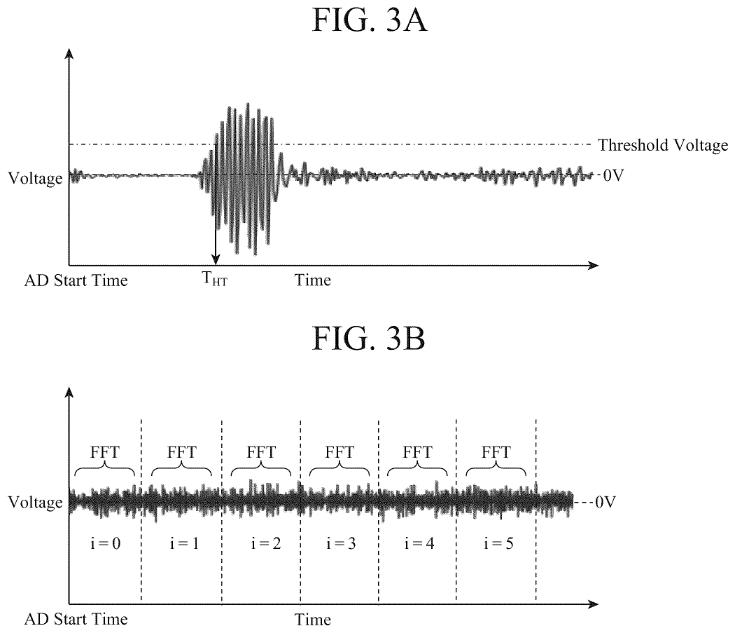

A graph in FIG. 3B shows that the spectrum conversion processing unit 13a divides a signal by a predetermined time window length, and repeats Fast Fourier Transformation (FFT) in each time window.

The time window length of FFT by the spectrum conversion processing unit 13a determines resolution in a range direction. The time window length of Fourier transform (At) and the resolution in the range direction (AL) have the following relationship.

$$Δ L = \frac{c Δ t}{2} \qquad ( 1 )$$

In this regard, c represents a light speed. The relational expression (1) is based on the principal of Time of Flight (TOF). Note that the reason why L is used as a symbol that indicates a range is that L derives from the capital letter of Length that is an English name of a distance.

FFT performed by the spectrum conversion processing unit 13a is FFT for calculating a peak frequency of the beat signal, that is, the Doppler frequency.

FIGS. 3A and 3B illustrate examples of graphs showing beat signal in time domain. The graph in FIG. 3B shows a case where the number of times of division (N) is six. The signal in the time domain divided into six is information on six range bins when FFT processing is performed. The term “bin” described here has the same meaning as that of a class or a section in a histogram. i=0, 1, . . . , and 5 in the graph in FIG. 3B is a label of a range bin. A distance (Lᵢ) indicated by an i-th range bin is obtained by multiplying a label i with range direction resolution (ΔL).

The integration processing unit 13b of the signal processing unit 13 performs integration processing on spectrum data obtained as a result of the FFT processing. The integration processing provides the same effect as that of averaging processing, and improves an SN ratio.

A time (Tᵢₙₜ) required for the integration processing is calculated as follows when the number of times of integration is M.

$${T}_{int} = \frac{M}{PRF} \qquad ( 2 )$$

In this regard, a PRF represents a pulse repetition frequency. A reciprocal of the PRF is a trigger cycle.

The spectrum data processed by the integration processing unit 13b is sent to the wind speed field calculation unit 13d together with information on the beam scanning direction from the corresponding beam scan optical system 10. The information sent from the integration processing unit 13b to the wind speed field calculation unit 13d is represented as a symbol Sₙ (Lᵢ, θ_{AZ}, θ_{EL}) in this description. Here, a subscript n represents an index, and details of n will be made apparent as described later.

Although the range direction resolution (ΔL) is determined on the basis of the time window length (Δt) of FFT as described above, the resolution of an angle is determined on the basis of a beam scanning speed of the beam scan optical system 10.

For example, it is assumed that, in the beam scan optical system 10, a beam is fixed in the EL direction, and the beam is scanned in the AZ direction at a certain angular velocity ω_{AZ} [deg/sec]. Since the time required for the integration processing is Tᵢₙₜ [sec] as described above, angular resolution (Δω_{AZ}) in the AZ direction is a value obtained by multiplying an angular velocity ω_{AZ} with an integration processing time Tᵢₙₜ.

As described above, the information sent by the integration processing unit 13b to the wind speed field calculation unit 13d is Lᵢ, θ_{AZ}, and θ_{EL}, but since the spectrum data (Sₙ) after the integration processing has a range of time, what point of time of θ_{AZ} and θ_{EL} Lᵢ is associated with is a design matter. Association may be performed by adopting, for example, an average value or a median value of θ_{AZ} and θ_{EL} in a time zone of the integration processing (from a time 0 that is a start time of 0 to a time Tᵢₙₜ). Furthermore, association may be performed by adopting θ_{AZ} and θ_{EL} at a start point of time (time 0) or an end point of time (time Tᵢₙₜ) of the integration processing.

The outline extraction unit 13c of the signal processing unit 13 is a functional block that performs processing when a radiated laser beam is reflected by a hard target such as a structure. FIGS. 3A and 3B illustrate examples of graphs showing beat signal in the time domain. A graph in FIG. 3A shows a beat signal in a case where a radiated laser beam is reflected by a hard target. As shown in the graph in FIG. 3A, the beat signal in a case where the laser beam is reflected by the hard target has a higher SN ratio, so that noise processing such as integration is unnecessary. That is, the magnitude of a signal is sufficiently large compared to the magnitude of noise.

The outline extraction unit 13c compares the magnitude of the beat signal with a preset threshold. In a case where the magnitude of the beat signal exceeds the threshold, the outline extraction unit 13c calculates a distance (L_{HT}) from the laser radar device to the hard target on the basis of a time (T_{HT}) taken until a reflected signal that has exceeded the threshold is received after start of beam radiation. The distance from the laser radar device to the hard target can be calculated as follows on the basis of the principal of TOF.

$${L}_{HT} = \frac{{cT}_{HT}}{2} \qquad ( 3 )$$

Note that subscripts HT are capital letters of Hard Target that is an English name of the hard target.

The distance (L_{HT}) to the hard target calculated by the outline extraction unit 13c is sent to the wind speed field calculation unit 13d together with information (θ_{AZ}, θ_{EL}) on the beam scanning direction from the corresponding beam scan optical system 10. The information sent from the outline extraction unit 13c to the wind speed field calculation unit 13d is represented as a symbol Cₙ (L_{HT}, θ_{AZ}, θ_{EL}) in this description.

Here, as described above, the subscript n represents the index, and n may be assigned, for example, a frame number. To put it simply, a frame number indicates the number of times of beam scan in the beam scan optical system 10. For example, similar to the above, it is assumed that, in the beam scan optical system 10, a beam is fixed in the EL direction, and the beam is scanned in the AZ direction at the certain angular velocity ω_{AZ} [deg/sec]. A dynamic range in the AZ direction is assumed as 0 [degree] to 90 [degrees]. Furthermore, it is assumed that a beam is scanned in the beam scan optical system 10 in such a manner that the beam makes a round trip in the AZ direction. An initial value (θ_{AZ}) of the azimuth angle is 0 [degree]. Performing scanning at the azimuth angle (θ_{AZ}) from 0 [degree] to 90 [degrees] is referred to as an outward trip, and performing scanning at the azimuth angle (θ_{AZ}) from 90 [degrees] to 0 [degree] is referred to as a return trip. A frame number (n) of a first outward trip from 0 [degree] that is the initial value of the time 0 to 90 [degrees] is 0. A frame number (n) of a first return trip from 90 [degrees] to 0 [degree] is 1. Subsequently, in accordance with the same rule, every time the azimuth angle (θ_{AZ}) reaches the end of the dynamic range, the frame number (n) is incremented.

The wind speed field calculation unit 13d of the signal processing unit 13 calculates a wind speed field on the basis of the information sent from the integration processing unit 13b, that is, Sₙ(Lᵢ, θ_{AZ}, θ_{EL}).

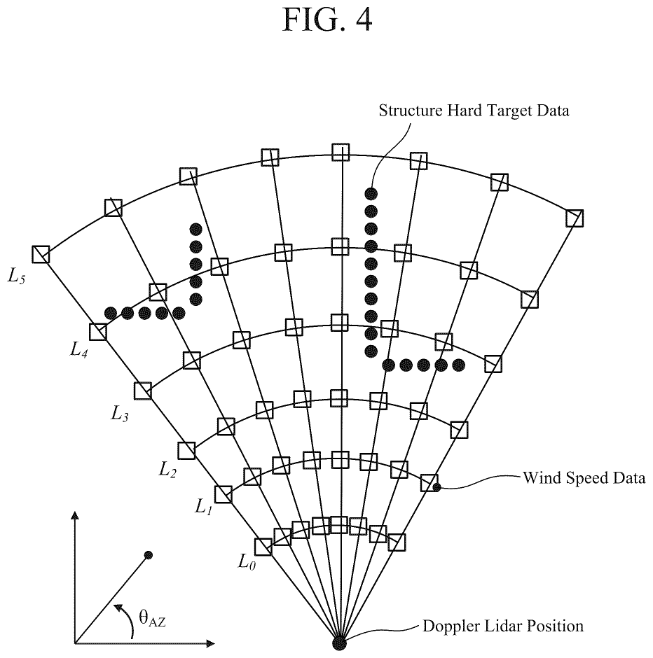

FIG. 4 illustrates an example of a map of an observation environment in which observation points of the laser radar device according to Embodiment 1 are expressed. In FIG. 4, white square plots indicate observation points at which wind speeds are measured. The observation points at which the wind speeds are observed appear at intersections of graduation lines of a polar coordinate system. Furthermore, in FIG. 4, black circular plots indicate observation points at which hard targets are observed. Note that FIG. 4 illustrates a case where a beam is fixed in the EL direction, and is scanned in the AZ direction.

Although not illustrated in FIG. 4, all laser beams are reflected without passing through hard targets, and therefore wind speeds cannot be observed at observation points that are blind spots of the hard targets. Data may be interpolated by the learning algorithm unit 13e to be described later at the observation points that are the blind spots of the hard targets.

The wind speed field calculation unit 13d calculates the Doppler frequency from a peak position of the spectrum at each of the observation points at which the wind speeds have been observed, and calculates a wind speed (v). When there are a plurality of peaks of a spectrum in a range bin, the center of gravity may be calculated to calculate the Doppler frequency. The wind speed (v) can be calculated on the basis of a relational expression with the following Doppler frequency (Δf).

$$v = \frac{λ}{2} Δ f \qquad ( 4 )$$

In this regard, A represents the wavelength of laser light output from the light source unit 1. The wind speed field calculation unit 13d calculates each wind speed (v) at a plurality of observation points in the observation environment as illustrated in FIG. 4. The calculated wind speed (v) at each of the observation points may be displayed as a “wind speed field” on the map.

According to the above processing steps of the wind speed field calculation unit 13d, the wind speed field information (vₙ(Lᵢ, θ_{AZ})) and the structure information (Cₙ(L_{HT}, θ_{AZ})) are calculated. The wind speed field information (vₙ(Lᵢ, θ_{AZ})) and the structure information (Cₙ(L_{HT}, θ_{AZ})) calculated by the wind speed field calculation unit 13d are sent to the learning algorithm unit 13e.

The wind speed (v) of the wind speed field information (vₙ(Lᵢ, θ_{AZ})) calculated in the processing steps of the wind speed field calculation unit 13d is merely a speed component in the laser radiation direction as described above. To obtain a wind speed field as provided by the AMeDAS live report (wind direction/wind speed) provided by the Japan Weather Association, at least two laser radar devices in a case of the two-dimensional live report and at least three laser radar devices in a case of the three-dimensional live report need to measure the same observation environment.

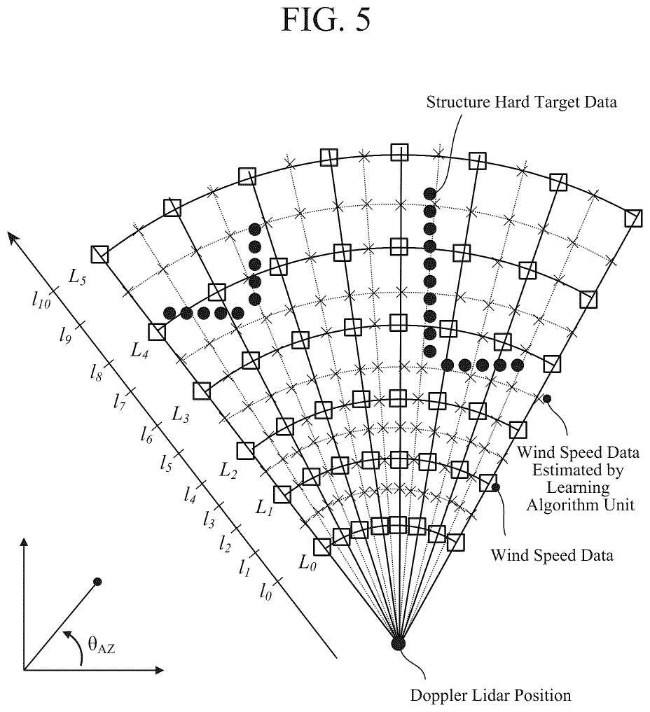

FIG. 5 illustrates an example of a map illustrating how the learning algorithm unit 13e of the signal processing unit 13 according to Embodiment 1 interpolates an observation result. To put it simply, the learning algorithm unit 13e interpolates the observation result as illustrated in FIG. 5. In FIG. 5, plots “x” indicate positions on the map interpolated by the learning algorithm unit 13e.

Note that, although not illustrated in FIG. 5, as described above, the learning algorithm unit 13e may also interpolate values at observation points that are blind spots of hard targets such as structures. Wind around buildings such as a separation flow, downwash, a reverse flow, a gap flow, wind at opening portions, street wind, and a vortex area blow in surroundings such as structures such as buildings in particular, and therefore it is very important to grasp a wind condition at portions that are blind spots.

The learning algorithm unit 13e has artificial intelligence configured by an artificial neural network or the like, and interpolates the observation result.

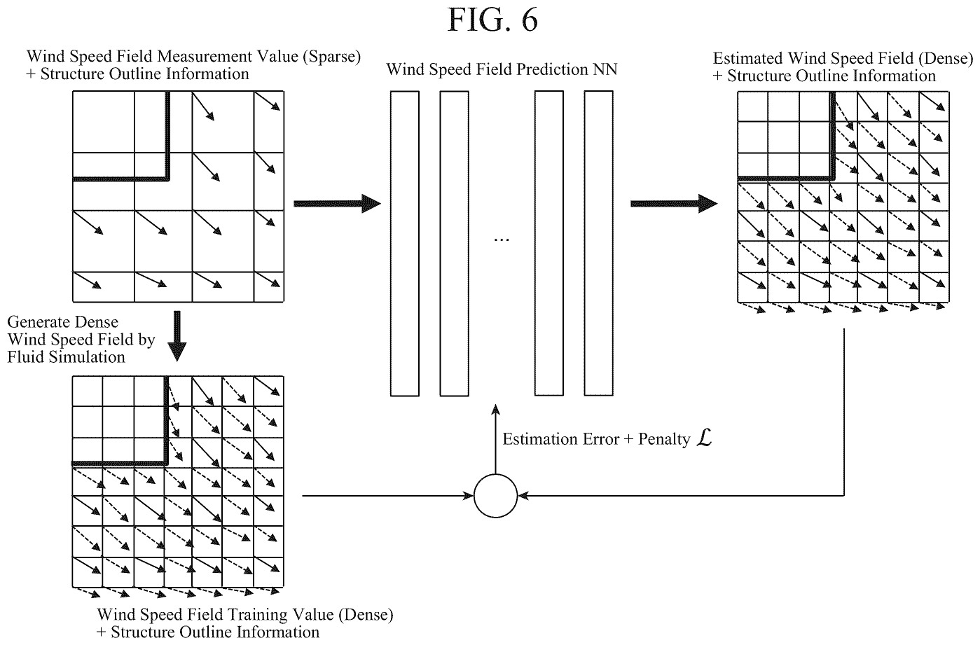

FIG. 6 is a schematic view illustrating the principal that the learning algorithm unit 13e of the signal processing unit 13 according to Embodiment 1 interpolates the observation result. A portion displayed as “wind speed field prediction NN” in FIG. 6 indicates the artificial neural network (hereinafter, simply referred to as a “neural network” or “NN”) included in the learning algorithm unit 13e.

Generally, a stage at which artificial intelligence performs learning is referred to as a “learning phase”, and a stage at which the trained artificial intelligence performs inference is referred to as an “inference phase”. It can be said that FIG. 6 illustrates an input and an output at the learning phase of the neural network included in the learning algorithm unit 13e.

“Wind speed field measurement value (sparse)+structure outline information” (hereinafter, referred to as “learning data A”) in FIG. 6 indicates a spatially sparse (scattered) wind speed field measurement value and outline information on a structure obtained by the laser radar device. The learning data A constitutes part of a learning data set.

“Wind speed field training value (dense)+structure outline information” (hereinafter, referred to as “learning data B”) in FIG. 6 is so-called training data, and constitutes the learning data set together with the learning data A. The learning data B may be generated by performing fluid simulation on the basis of, for example, the learning data A. Fluid simulation may use, for example, a Computational Fluid Dynamics (CFD) method. Note that fluid simulation of creating training data may be performed by a calculation resource such as a calculator different from the signal processing unit 13 of the laser radar device.

The training data may be created by fluid simulation together with the learning data A and the learning data B. Furthermore, all items of training data may be actual measurement data as long as the training data can be obtained.

Note that, although FIG. 6 illustrates the learning data A and the learning data B by dividing space into a lattice pattern like an orthogonal coordinate system, space may be divided like a polar coordinate system as in FIG. 5.

The “estimated wind speed field (dense)+structure outline information” in FIG. 6 indicates an output of the neural network of the learning algorithm unit 13e. In a case where the learning data B that is the training data is used as a reference, an output of the neural network includes an estimation error. The neural network of the learning algorithm unit 13e may advance learning in such a manner to minimize an evaluation function (indicated by L of the script font in FIG. 6) obtained by adding a penalty term to this estimation error.

The artificial intelligence included in the learning algorithm unit 13e preferably performs learning using the learning data set in a situation that various assumptions can be made as much as possible.

Note that the artificial intelligence may perform leaning in a development environment different from that of the signal processing unit 13 of the laser radar device. In this case, a mathematical model of the artificial intelligence trained in the different development environment may be transferred to the learning algorithm unit 13e in a state where parameters are optimized after training is completed.

The learning algorithm unit 13e at the inference phase includes the trained artificial intelligence, that is, the mathematical model having the optimized parameters.

The learning algorithm unit 13e at the inference phase can interpolate the observation result on the basis of the wind speed field information (vₙ(Lᵢ, θ_{AZ})) and the structure information Cₙ(L_{HT}, θ_{AZ})) sent from the wind speed field calculation unit 13d, and generate dense wind speed field data in a much shorter time than a time required to perform fluid simulation.

It is also conceived to make wind speed field data dense by a solution of increasing a frame rate or increasing a scanning speed of the laser radar device. However, these solutions have a limitation, and lead to an increase in cost.

### <<Application Example of Laser Radar Device>>

It is conceived to apply the laser radar device according to the technique of the present disclosure to navigation assistance of aerial moving bodies such as airplanes or drones that move in air.

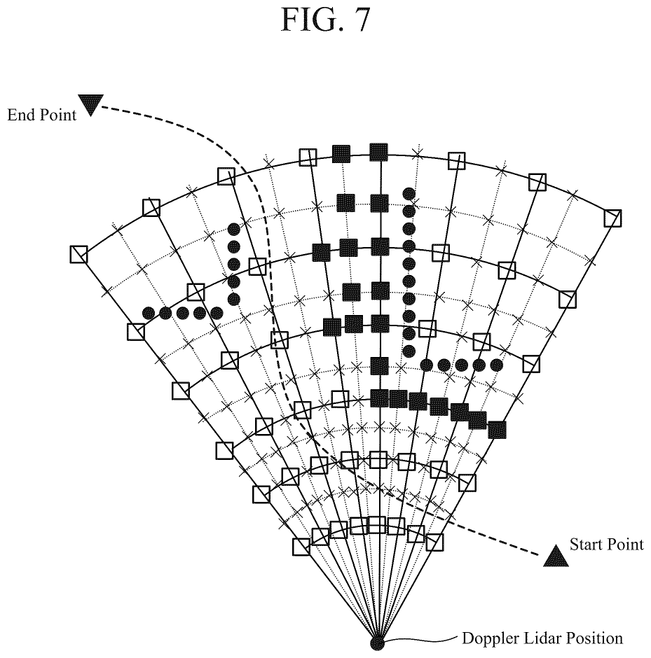

FIG. 7 illustrates an example of a map in a case where the laser radar device according to Embodiment 1 is applied to navigation assistance of the aerial moving body. A broken line curve illustrated in FIG. 7 indicates a movement route of the aerial moving body. Furthermore, an upward black triangle “▴” illustrated in FIG. 7 indicates a start point of the movement route, and a downward black triangle “▾” indicates an end point of the movement route.

Black squares “▪” illustrated in FIG. 7 indicate observation positions at which wind speeds that are dangerous for the aerial moving body are observed. In a case where, for example, the aerial moving body is a drone, the laser radar device indicates observation points at which a wind speed is dangerous for the drone, that is, for example, the wind speed is 5 [m/sec] or more in a mode different from those of other observation points, and indicate dangerous sites. FIG. 7 illustrates that the technique of the present disclosure can set the movement route of the aerial moving body by avoiding sites indicated as dangerous sites. Note that the threshold of the wind speed that is determined as a dangerous wind speed may be determined as appropriate depending on the type, a situation of use, and the like of the aerial moving body.

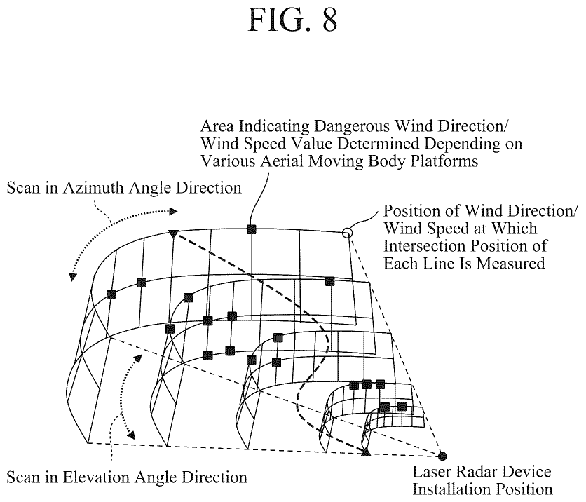

When the beam scan optical system 10 scans a beam by combining scanning in the EL direction and scanning in the AZ direction, resulting three-dimensional information is as illustrated in, for example, FIG. 8.

FIG. 8 illustrates an example of a three-dimensional map in a case where the laser radar device according to Embodiment 1 is applied to navigation assistance of the aerial moving body. Broken lines and each plot illustrated in FIG. 8 are used in the same meaning as those in FIG. 7.

The technique of the present disclosure has been described as the technique of the laser radar device, yet is not limited to this. According to the technique of the present disclosure, the learning algorithm unit 13e may interpolate data between sensors such as ultrasonic anemometers in a system in which the sensors are provided in crowd arrangement.

The laser radar device according to the technique of the present disclosure may simultaneously acquire wind speed field data and acquire outline information, or alternately repeat acquiring the wind speed field data and the outline data. Furthermore, the laser radar device according to the technique of the present disclosure may acquire wind speed field data and acquire outline information the same number of times or a different number of times.

The laser radar device according to the technique of the present disclosure may acquire wind speed field data and acquire outline information in accordance with the same scanning pattern or different scanning patterns. Furthermore, the laser radar device according to the technique of the present disclosure may make parameters such as scanning speeds, scanning ranges, and the like the same or different to acquire wind speed field data and acquire outline information.

### Embodiment 2

Although the laser radar device according to Embodiment 1 adopts a mode that the laser radar device itself measures outline information of a structure, the technique of the present disclosure is not limited to this.

A laser radar device according to Embodiment 2 adopts a mode that the laser radar device acquires outline information of a structure using other means.

The same reference numerals as those in Embodiment 1 will be used in Embodiment 2 unless specified otherwise. Furthermore, Embodiment 2 will omit description that overlaps those in Embodiment 1 as appropriate.

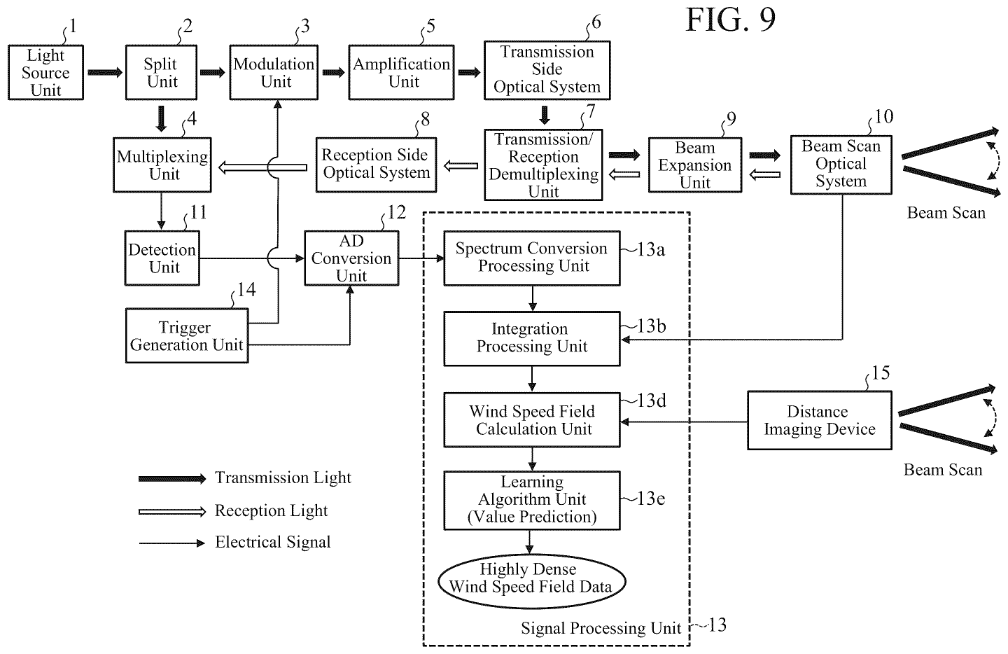

FIG. 9 is a block diagram illustrating a configuration of the laser radar device according to Embodiment 2. In FIG. 9, a distance imaging device 15 that is the other means for acquiring outline information of a structure is illustrated in place of the outline extraction unit 13c.

The distance imaging device 15 illustrated in FIG. 9 may be, for example, a Lidar such as an imaging Lidar. The distance imaging device 15 may measure outline information of a structure on the basis of, for example, the principal of TOF.

The distance imaging device 15 obtains positions of hard targets such as structures from measured distance image data. A result detected by the distance imaging device 15 is sent to the wind speed field calculation unit 13d of the signal processing unit 13.

The wind speed field calculation unit 13d of the signal processing unit 13 according to Embodiment 2 performs the same processing as the processing performed on the output of the outline extraction unit 13c according to Embodiment 1 on the result detected by the distance imaging device 15.

The distance imaging device 15 only needs to be able to measure the hard targets such as the structures, and do not need to measure a wind speed. That is, the distance imaging device 15 specialized and designed to measure distances to the hard targets can be used.

It is important for the laser radar device according to Embodiment 2 to share the same spatial coordinate system to use a measurement result of the distance imaging device 15.

Structures such as buildings among the hard targets make no dynamic behavior. The structures move very slowly over not so long a distance even if there is any movement. Accordingly, a measurement frequency of the hard targets by the distance imaging device 15 may be much less than a measurement frequency of a wind speed by the laser radar device. In this regard, taking into account that data has credibility and is used as an evidence, the distance imaging device 15 may include a clock that is synchronized with the laser radar device as necessary.

Since structures make no dynamic behavior, the laser radar device according to the technique of the present disclosure may use map information provided by the Geospatial Information Authority of Japan or the like in place of the measurement result of the distance imaging device 15.

Although the laser radar device according to the technique of the present disclosure handles a reflected signal from aerosol in the atmosphere, the signal strength of the reflected signal from the aerosol is generally very low. Hence, the laser radar device according to the technique of the present disclosure has a relatively wide pulse width.

On the other hand, it is possible to improve distance resolution of measurement of hard targets such as structures by narrowing the pulse width. Thus, the signal strength and the distance resolution have a trade-off relationship.

The laser radar device according to the technique of the present disclosure is specialized in measurement of a wind speed similar to the mode described in Embodiment 2, and solves a trade-off problem using the distance imaging device 15 that is a different device that detects positions of hard targets such as structures.

As described above, the laser radar device according Embodiment 2 solves the trade-off problem, and provides the same effect as that of the laser radar device according to Embodiment 1.

### INDUSTRIAL APPLICABILITY

The laser radar device according to the technique of the present disclosure is applicable to a navigation assistance system such as for drones, and has industrial applicability.

### REFERENCE SIGNS LIST

1: light source unit, 2: split unit, 3: modulation unit, 4: multiplexing unit, 5: amplification unit, 6: transmission side optical system, 7: transmission/reception demultiplexing unit, 8: reception side optical system, 9: beam expansion unit, 10: beam scan optical system, 10a: azimuth angle change mirror, 10b: elevation angle change mirror, 10c: rotation control unit, 11: detection unit, 12: AD conversion unit, 13: signal processing unit (signal processor), 13a: spectrum conversion processing unit (spectrum conversion processor), 13b: integration processing unit (integration processor), 13c: outline extraction unit, 13d: wind speed field calculation unit (wind speed field calculator), 13e: learning algorithm unit (algorithm learning AI), 14: trigger generation unit, 15: distance imaging device.

What is claimed is:

1. A laser radar device that scans a laser beam and measures a wind speed field of observation environment, further comprising a signal processor including a spectrum conversion processor, an integration processor, a wind speed field calculator, and a algorithm learning AI, wherein
the spectrum conversion processor performs FFT processing on a beat signal that is a time-series digital signal, and generates spectrum data,
the integration processor performs integration processing on the spectrum data,
the wind speed field calculator calculates the wind speed field by referring to information on data processed by the integration processor, and
the algorithm learning AI includes a trained artificial intelligence, and interpolates an observation result by referring to information on the wind speed field,
the wind speed field calculator calculates information on a structure in the observation environment in addition to the information on the wind speed field, and,
the algorithm learning AI interpolates an observation point, even if the point to be interpolated is a blind spot of the structure in the observation environment.

2. The laser radar device according to claim 1, wherein the trained artificial intelligence is a neural network.
